(19) United States
(12) Patent Application Publication
(10) Pub. No.: US 2015/0316038 A1
(43) Pub. Date: Nov. 5, 2015

(54) Energy for all seasons

(71) Applicant: Svetozar B. Petrovich, Chicago, IL (US)

(72) Inventor: Svetozar B. Petrovich, Chicago, IL (US)

(21) Appl. No.: 13/999,086

(22) Filed: Jan. 10, 2014

Related U.S. Application Data
(63) Continuation-in-part of application No. PCT/US2012/000572, filed on Dec. 6, 2012.
Application No. PCT/US2012/000572 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. PCT/US2012/000572 is a continuation-in-part of application No. 13/506,098, filed on Mar. 27, 2012, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/506,098 is a continuation-in-part of application No. 13/136,140, filed on Jul. 25, 2011, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/068,587 is a continuation-in-part of application No. 12/153,036, filed on May 13, 2008, now abandoned.
Application No. 13/136,140 is a continuation-in-part of application No. 13/135,617, filed on Jul. 11, 2011, now abandoned.
Application No. 13/135,617 is a continuation-in-part of application No. 13/068,587, filed on May 16, 2011, now abandoned.
Application No. 13/068,587 is a continuation-in-part of application No. 12/320,441, filed on Jan. 26, 2009, now abandoned.
Application No. 12/320,441 is a continuation-in-part of application No. 12/153,036, filed on May 13, 2008, now abandoned.
Application No. 12/153,036 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. 13/135,617 is a continuation-in-part of application No. 13/068,587, filed on May 16, 2011, now abandoned.
Application No. 13/068,587 is a continuation-in-part of application No. 12/320,441, filed on Jan. 26, 2009, now abandoned.
Application No. 12/320,441 is a continuation-in-part of application No. 12/153,036, filed on May 13, 2008, now abandoned.
Application No. 12/153,036 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. 13/068,587 is a continuation-in-part of application No. 12/658,099, filed on Feb. 1, 2010, now abandoned.
Application No. 12/658,099 is a continuation-in-part of application No. 12/453,444, filed on May 12, 2009, now abandoned.
Application No. 12/453,444 is a continuation-in-part of application No. 12/320,441, filed on Jan. 26, 2009, now abandoned.
Application No. 12/320,441 is a continuation-in-part of application No. 12/153,036, filed on May 13, 2008, now abandoned.
Application No. 12/153,036 is a continuation-in-part of application No. PCT/US2010/001379, filed on May 10, 2010.
Application No. PCT/US2010/001379 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/001379 is a continuation-in-part of application No. 12/658,099, filed on Feb. 1, 2010, now abandoned.
Application No. 12/658,099 is a continuation-in-part of application No. 12/453,444, filed on May 12, 2009, now abandoned.
Application No. 12/453,444 is a continuation-in-part of application No. 12/320,441, filed on Jan. 26, 2009, now abandoned.
Application No. 12/320,441 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/000187 is a continuation-in-part of application No. 12/153,036, filed on May 13, 2008, now abandoned.
Application No. 12/658,099 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/382,441, filed on Mar. 17, 2009, now abandoned.
Application No. 12/382,441 is a continuation-in-part of application No. 12/382,440, filed on Mar. 17, 2009, now Pat. No. 7,742,300.
Application No. 12/382,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 11/724,752 is a continuation-in-part of application No. PCT/US2010/000188, filed on Jan. 25, 2010.
Application No. PCT/US2010/000188 is a continuation-in-part of application No. PCT/US2010/000187, filed on Jan. 25, 2010.
Application No. PCT/US2010/000188 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/382,441, filed on Mar. 17, 2009, now abandoned.
Application No. 12/382,441 is a continuation-in-part of application No. 12/382,440, filed on Mar. 17, 2009, now Pat. No. 7,742,300.
Application No. 12/382,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. PCT/US2010/000187 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/382,441, filed on Mar. 17, 2009, now abandoned.
Application No. 12/382,441 is a continuation-in-part of application No. 12/382,440, filed on Mar. 17, 2009, now Pat. No. 7,742,300.
Application No. 12/382,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 12/453,444 is a continuation-in-part of application No. 12/382,448, filed on Mar. 17, 2009, now abandoned.
Application No. 12/382,448 is a continuation-in-part of application No. 12/382,441, filed on Mar. 17, 2009, now abandoned.
Application No. 12/382,441 is a continuation-in-part of application No. 12/382,440, filed on Mar. 17, 2009, now Pat. No. 7,742,300.
Application No. 12/382,440 is a continuation-in-part of application No. 12/153,036, filed on May 13, 2008, now abandoned.
Application No. 12/153,036 is a continuation-in-part of application No. 11/724,752, filed on Mar. 15, 2007, now abandoned.
Application No. 12/320,441 is a continuation-in-part of application No. 12/153,036, filed on May 13, 2008, now abandoned.
Application No. 12/153,036 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/724,752, filed on Mar. 15, 2007, now abandoned.
Application No. 12/153,036 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/788,172, filed on Jun. 4, 2007, now abandoned.
Application No. 11/788,172 is a continuation-in-part of application No. 11/724,752, filed on Mar. 15, 2007, now abandoned.
Application No. 11/809,132 is a continuation-in-part of application No. 11/807,748, filed on May 30, 2007, now abandoned.
Application No. 11/807,748 is a continuation-in-part of application No. 11/724,752, filed on Mar. 15, 2007, now abandoned.
Application No. 11/724,752 is a continuation-in-part of application No. 11/504,304, filed on Aug. 14, 2006, now abandoned.
Application No. 11/807,748 is a continuation-in-part of application No. 11/724,752, filed on Mar. 15, 2007, now abandoned.
Application No. 11/724,752 is a continuation-in-part of application No. 11/504,304, filed on Aug. 14, 2006, now abandoned.
Application No. 11/504,304 is a continuation-in-part of application No. 11/385,078, filed on Mar. 20, 2006, now abandoned.
Application No. 11/788,172 is a continuation-in-part of application No. 11/724,752, filed on Mar. 15, 2007, now abandoned.
Application No. 11/724,752 is a continuation-in-part of application No. 11/504,304, filed on Aug. 14, 2006, now abandoned.
Application No. 11/504,304 is a continuation-in-part of application No. 11/385,078, filed on Mar. 20, 2006, now abandoned.
Application No. 11/724,752 is a continuation-in-part of application No. 11/504,304, filed on Aug. 14, 2006, now abandoned.
Application No. 11/504,304 is a continuation-in-part of application No. 11/418,157, filed on May 3, 2006, now abandoned.
Application No. 11/418,157 is a continuation-in-part of application No. 11/385,078, filed on Mar. 20, 2006, now abandoned.
Application No. 11/504,304 is a continuation-in-part of application No. 11/418,157, filed on May 3, 2006, now abandoned.
Application No. 11/418,157 is a continuation-in-part of application No. 11/385,078, filed on Mar. 20, 2006, now abandoned.
Application No. 11/385,078 is a continuation-in-part of application No. 11/342,006, filed on Jan. 30, 2006, now abandoned.
Application No. 11/418,157 is a continuation-in-part of application No. 11/385,078, filed on Mar. 20, 2006, now abandoned.
Application No. 11/385,078 is a continuation-in-part of application No. 11/342,006, filed on Jan. 30, 2006, now abandoned.
Application No. 11/342,006 is a continuation-in-part of application No. 11/233,546, filed on Sep. 23, 2005, now abandoned.
Application No. 11/385,078 is a continuation-in-part of application No. 11/342,006, filed on Jan. 30, 2006, now abandoned.
Application No. 11/342,006 is a continuation-in-part of application No. 11/233,546, filed on Sep. 23, 2005, now abandoned.
Application No. 11/233,546 is a continuation-in-part of application No. 11/212,943, filed on Aug. 25, 2005, now abandoned.
Application No. 11/342,006 is a continuation-in-part of application No. 11/233,546, filed on Sep. 23, 2005, now abandoned.
Application No. 11/233,546 is a continuation-in-part of application No. 11/212,943, filed on Aug. 25, 2005, now abandoned.
Application No. 11/233,546 is a continuation-in-part of application No. 11/212,943, filed on Aug. 25, 2005, now abandoned.
Application No. 11/212,943 is a continuation-in-part of application No. 11/188,339, filed on Jul. 25, 2005, now abandoned.
Application No. 11/188,339 is a continuation-in-part of application No. 10/869,752, filed on Jun. 16, 2004, now abandoned.
Application No. 11/212,943 is a continuation-in-part of application No. 11/188,339, filed on Jul. 25, 2005, now abandoned.
Application No. 11/188,339 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 11/188,339 is a continuation-in-part of application No. 11/028,982, filed on Jan. 3, 2005, now abandoned.
Application No. 11/028,982 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 11/028,982 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 10/840,152 is a continuation-in-part of application No. 10/742,485, filed on Dec. 19, 2003, now abandoned.
Application No. 10/869,752 is a continuation-in-part of application No. 10/840,152, filed on May 5, 2004, now abandoned.
Application No. 10/840,152 is a continuation-in-part of application No. 10/742,485, filed on Dec. 19, 2003, now abandoned.
Application No. 10/742,485 is a continuation-in-part of application No. 10/156,192, filed on May 28, 2002, now abandoned.
Application No. 10/840,152 is a continuation-in-part of application No. 10/742,485, filed on Dec. 19, 2003, now abandoned.
Application No. 10/742,485 is a continuation-in-part of application No. 10/190,993, filed on Jul. 8, 2002, now abandoned.
Application No. 10/190,993 is a continuation-in-part of application No. 10/156,192, filed on May 28, 2002, now abandoned.
Application No. 10/742,485 is a continuation-in-part of application No. 10/190,993, filed on Jul. 8, 2002, now abandoned.
Application No. 10/190,993 is a continuation-in-part of application No. 10/156,192, filed on May 28, 2002, now abandoned.
Application No. 10/190,993 is a continuation-in-part of application No. 10/156,192, filed on May 28, 2002, now abandoned.
Application No. 10/156,192 is a continuation-in-part of application No. 10/073,914, filed on Feb. 14, 2002, now abandoned.
Application No. 10/073,914 is a continuation-in-part of application No. 09/850,297, filed on May 8, 2001, now Pat. No. 6,412,947.
Application No. 10/156,192 is a continuation-in-part of application No. 10/074,966, filed on Feb. 13, 2002, now abandoned.
Application No. 10/074,966 is a continuation-in-part of application No. 09/850,297, filed on May 8, 2001, now Pat. No. 6,412,947.
Application No. 10/074,966 is a continuation-in-part of application No. 09/850,297, filed on May 8, 2001, now Pat. No. 6,412,947.
Application No. 10/073,914 is a continuation-in-part of application No. 09/850,297, filed on May 8, 2001, now Pat. No. 6,412,947.
Application No. 09/850,297 is a continuation-in-part of application No. 09/518,884, filed on Mar. 6, 2000, now abandoned.
Application No. 09/518,884 is a continuation-in-part of application No. 09/376,957, filed on Aug. 18, 1999, now abandoned.
Application No. 09/376,957 is a continuation-in-part of application No. 09/376,957, filed on Aug. 18, 1999, now abandoned.
Application No. 09/376,957 is a continuation-in-part of application No. 08/950,898, filed on Oct. 15, 1997, now Pat. No. 5,941,273.
(60) Provisional application No. 60/231,514, filed on Sep. 9, 2000.
(60) Provisional application No. 60/226,750, filed on Aug. 21, 2000.
(60) Provisional application No. 60/220,358, filed on Jul. 24, 2000.
(60) Provisional application No. 60/217,308, filed on Jul. 11, 2000.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.

(51) Int. Cl. F03G 7/00

(52) U.S. Cl. CPC F03G 7/00

(57) ABSTRACT

A PMIISP affects thermal, static and dynamic loads and displacements symmetry in symmetry plane; confining structures electromagnetic fluid electromagnetic devices affect displacements in that plane and/or movements comprising vectorial sum in that plane with only infinitesimal other movements; axial displacements governing expansion and contraction electromagnetic device, in such plane, spawns high energy piping composite construction only preferred stressing, which by dissipating yields the PMIISP mechanical and thermal optimal efficiencies operational longevity; structures of the devices and confined fluid stiffness—elastic, shear, and bulk moduli spawned by power input into electromagnets—preclude other displacements; number of the planes is elective; and high energy piping optimally horizontal routings and condenser units cooling water optimum conservation orient the planes of symmetry and cooling water gravity flow means for flooding of annex and containment building portions up to the reactor vessel head set the PMIISP elevations.

The following lists Domestic Priority data. This application

is “a 371 of international” PCT/US2012/00319 Jul. 11, 2012
and a continuation in part of these application Ser. Nos.
13/506,098 Mar. 27, 2012 and
13/135,617 Jul. 11, 2011 and
PCT/US2012/000572 Dec. 6, 2012 and
13/136,140 Jul. 25, 2011 and
13/068,587 May 16, 2011 and
12/658,099 Feb. 1, 2010 and
PCT/US210/000187 Jan. 25, 2010 and
PCT/US210/000188 Jan. 25, 2010 and
12/453,444 May 12, 2009 and,
12/382,448 Mar. 17, 2009 and
12/320,441 Jan. 26, 2009 and
12/320,440 Jan. 26, 2009 and
12/153,036 May 13, 2008 and
11/809,132 May 31, 2007 and
11/807,748 May 30, 2007 and
11/788,172 Jun. 4, 2007 and
11/724,752 Mar. 15, 2007 and said
11/809,132 May 31, 2007 and said
11/807,748 May 30, 2007 and said
11/788,172 Jun. 4, 2007 and
11/504,304 Jun. 14, 2006 and
11/385,078 Mar. 20, 2006 and said
11/724,752 Mar. 15, 2007 and
11/418,157 May 3, 2006 and
11/342,006 Jan. 30, 2006 and
11/233,546 Sep. 23, 2005 and
11/212,943 Aug. 25, 2005 and
11/188,339 Jul. 25, 2005 and
11/028,982 Jan. 3, 2005 and
10/869,752 Jun. 16, 2004 and
10/840,152 May 5, 2004 and
10/742,485 Dec. 19, 2003 and
10/190,993 Jul. 8, 2002 and
10/156,192 May 28, 2002 and
10/074,966 Feb. 13, 2002 and
09/850,927 May 8, 2001 and
09/518,884 Mar. 6, 2000 and
09/376,957 Aug. 18, 1999 and said
10/869,752 Jun. 16, 2004 and said
10/840,152 May 5, 2004 and said
10/156,192 May 28, 2002 and said
10/074,966 Feb. 13, 2002 and said
09/850,927 May 8, 2001 and said
09/518,884 Mar. 6, 2000 and said
09/376,957 Aug. 18, 1999 and said
10/869,752 Jun. 16, 2004 and
10/195,668 Jul. 15, 2002 and
10/073,914 Feb. 14, 2002 and said
09/850,927 May 8, 2001 and said
09/518,884 Mar. 6, 2000 and said
09/376,957 Aug. 18, 1999 and said
10/742,485 Dec. 19, 2003 and said
10/156,192 May 28, 2002 and said
10/190,993 Jul. 8, 2002 and said
10/073,914 Feb. 14, 2002 and said
10/074,966 Feb. 13, 2002 and said
09/850,927 May 8, 2001 and said
09/518,884 Mar. 6, 2000 and said
09/376,957 Aug. 18, 1999 and said
09/850,927 May 8, 2001 claims benefit of
60/231,514 Sep. 9, 2000 and claims benefit of
60/226,750 Aug. 21, 2000 and claims benefit of
60/220,358 Jul. 24, 2000 and claims benefit of
60/217,308 Jul. 11, 2000 and said
09/518,884 Mar. 6, 2000 (contains said 09/376,957 Aug. 18, 1999) and claims benefit of
60/123,504 Mar. 9, 1999 and claims benefit of
60/123,207 Mar. 8, 1999 and claims benefit of
60/123,153 Mar. 6, 1999 and said
09/376,957 Aug. 18, 1999 and claims benefit of
60/123,504 Mar. 9, 1999 and claims benefit of
60/123,207 Mar. 8, 1999 and claims benefit of
60/123,153 Mar. 6, 1999 and said
09/376,957 Aug. 18, 1999 and
08/950,898 Oct. 15, 1997, U.S. Pat. No. 5,941,273

### FIELD OF THE INVENTION

Sustainable atomic energy uniquely configured nuclear plant is bulk energy sole and true source.

### BACKGROUND OF THE INVENTION

Herein, invention novelties rudimentarily atone global air warming epigene processes and global energy crisis spawned water resources depletion, by fundamentally applying science to Universe functions, which reveals the entire prior art technologies improperly and unnecessarily presumed complexity constraints which imperil our civilization thru deeply flawed bulk energy production.

The priority applications, herewith continues, starting from Tesla and Einstein full agreements on existence of ether; in a pursuit of defining universal gravitation, Einstein departs from Newtonian gravitation with the general theory of relativity and at one time proposes a cosmological constant which he later calls his greatest blunder. Higgs at all, redefine ether, in Higgs subatomic domain.

To account for practical applications of gravitational effects, the theory of relativity must depend on concept of curved space-time, documented in literature with significant agreements and fierce oppositions. Simply put, curvature of space time does not possess dynamics that arise from local quantum energy environmental effects. Such real effects not accounted in the theory of relativity constitute “forbidden mechanisms” non-mechanical or illogical nonzero probability events which occur to spawn chains of such mechanisms, within the Earth's gravitational field innate function.

Since the advent of said theory almost hundred years ago, no utilization is envisioned for science therein theorized. Instead, apparent flaws in the theory are becoming evident, as true solutions to energy issues, within these patent applications, point out and disclose; the Higgs field offers even less and no clue at all as to theorized science potential transferring into a practical energy device.

We need solution—now technologies—to energy issues that arise from the environment, which is exactly what these patent applications do, constituting solution of the Theories of Uniformity and Everything. These undeniable solutions correlate and importantly validate themselves, in Tesla's fashion, thru crucial practical devices proven technologies to everything mass and energy related, constituting innovations that do no rely on theorized subatomic particle functions, or phenomena.

### SUMMARY OF THE INVENTION

An Advanced Processor magma, mantle, and magnetic field lines fluid couple mantle-coupled groundwater, polar caps and glaciers, less couple oceans with continental waters, partly decouple atmospheric fluids and least couple ionosphere ions and electrons mass, in magnetosphere bound compositions mass of light fluids quanta; light fluids magnetosphere perfect boundaries mass and energy highest conserving (MEHC) quintessential core natural disposition (QCNDMEHC) yields boundaries complete compliments, stressed by volume changes energy of distortion; bound mass fluid compositions force stratifications, gradations, and forbidden mechanisms, to distort, deform and distend dispositions of perfect boundaries complete complements and force Jean's fountains, forbidden mechanisms plasma outflows; innovations, inventions, principles, methodologies, Ions and Isotopes (FEIIPMII), the Advanced Processor and Fluid Elements genus, by quantum energy algorithms computing principles, methodologies, innovations and inventions (PMII) technologies comprise boundaries perfection and sui generis boundaries perfection tracings of globose conduit Sets, entirely replicating Advanced Processors—Advanced Fluid Elements. Genus genres shown boundaries yield the suit generis boundaries with genres of genus that effectuate domains of Sets. Ubiquitous clustering of said sui generis boundaries and the FEIIPMII, PMII and Fluid Elements into Sets of nuclear super plants (SPs) own solely key means for crucial relief from global energy demand, water scarcity, and innate and anthropogenic global warming (AGW) and crucial means for abating suctions that force the magnetic field lines periodic disconnects at shoulders of cusps.

The Earth fluids evolve stratified, forms equal functions, globose boundaries, as the gravitational sink and magnetic field shield molecular, atomic and plasma fluids, bound by the magnetosphere boundaries which the solar and cosmic wind pressures and radiations force into immense fluxing. In applied magnetic field sciences, applied technologies must conform to the Universe functions, forms equal functions that equal forms, which drive and balance the Universe innate imbalances; sciences true technologies must first and foremost entirely conform to true Laws of the Universe; the prior art does not even conform to the Earth's functions, creating ubiquitous longevity issues. Aforesaid briefly summarize global air warming root causal effects that threaten this civilization.

Later referenced applications detail, Newton time's known, light fluid mass and energy dynamics which Newtonian Shell Theory misses, in insufficient gravitational dynamics model. In Theories of Relativity, Einstein calls for gravitational dynamics cosmological constant fudge factor, which he scraps later and excludes science of contemporaries in favor of curved space-time hypotheses.

An entirely frozen surface of a planet spawns mass energy gravitational unit boundary perfection which sustains indefinable longevity or infinity longevity, as long as that surface remains entirely frozen. Boulders, wash gravel and rounded sand grains affect respective gravitational boundaries constituted longevities, forced by climate changes in environment, wherein the letter boundary is derived from the prior boundary environmentally inflicted breakups. Atomic elements constitute boundaries perfection that is subject to breakdown on extremely rare mass energy collisions, thus comprising almost infinite longevity boundaries. Consequently, it is fair to say that hydrogen, as atomic element 1, comprises smallest gravitational unit that is known to have almost infinite life, wherein subatomic particles, as gravitational quantum, embody short to infinitesimal longevities.

From revelations in sciences, the Universe evolved from gaseous fluids that spawned the planets, comprising mass and energy gravitational units with corresponding boundaries perfection, whose boundaries perfection geneses originate from gaseous fluids depressions, gravitational sinks, and gravitational dynamics. Referring to gravitational attractions, as gravitational sinks, is consistent with sciences, as evident in celestial bodies light fluids mass and energy gravitational boundaries perfection innate evolutions, consistent with fluids potential energy levels. Thus, the Newtonian gravitational constant varies; with mass energy and thus forced orbital changes of the two bodies, that constant depends on time, as its equivalence changes in time frames relatively short interval.

Rotating globose and spiral galaxies, as well as those that appear stationary, subdivided into a set of concentric spherical shells constitute outermost shell retained celestial bodies which emit light fluids mass energy, plasma, into adjacent inner shell wherein successive shells contribute to light fluids plasma streaming continuum toward galactic center Black Hole. The streaming continuum that spins for billions of years as gravitational depression embodies therein retained heavier fluid.

Geological and astronomical evidence reveal fundamentals of unconfined redistributions of mass and energy by gravitational dynamics. The priority data, the referenced applications, reveal stars and to much lesser extent planets work as emitters and receivers of redistributed light fluids mass energy; in difference to “classical sciences” gravitational theories, the gravitation dynamics force means for volume and mass energy potential level change by forcing fluid phase recurring cycles environment and celestial bodies, the gravitational sinks, mass with energy redistributions and by Black Hole stratification gradation processes compaction that reconfigures boundaries perfection of the gravitational units assimilated into one fluid boundary; all of which lower potential energy level of celestial bodies, galaxy effectuated Black Hole processes compaction and the light fluids continuum that sustain the galaxy and celestial bodies boundaries perfection with respective spin.

The gravitation dynamics force magnetic fields and environment dynamics—environment energy superimposed dynamics, EESD, intensity participations specific versions of gravitational lensing, universal presence—effectuating omnipresent Universe dynamics—evolve in-situ dynamics of the gravitational units said boundaries perfection, which yield balancing of the Universe and embody mass and energy that oppose “classical” theories redundancies of hypothesize curved space time. Gravitational lensing, atomic clocks gravitational dilation comprises gravitation, magnetic fields, and environment superimposed dynamics, the superimposed dynamics effectuated longevities of boundaries perfection respective observations revelations and not evidence of curved space time.

Stunning evidence exists of exactitude which balances the Universe for 13.5 billion years and the Solar System for 4.5 billion years and yields “fine-tuning” evolution of the boundaries perfection spawned by and in environment of the superimposed dynamics—the Universe dynamics. Priority U.S. application Ser. No. 13/506,098, Everything Genres and Everything Solutions, details paradigms of the exactitude that correlates genres of the Earth's magnetosphere quantum energy constituted boundaries perfection and those of Second Fluid Elements, said Sets, including a globose-inverse Set, which are the paradigms of said dynamics existing exactitudes from deep space into epigene, “a geologic process operating at or near the earth's surface” and “a structure at or near the earth's surface”—a globose crust in geology; said surface embodies boundary of surfaces and processes.

In said Set, as drain trap spawned fluid boundaries perfection, no magnetic field and environment dynamics, while present, effectuate a discernable effect, compared to gravitational sink dynamics constituted up and down force two directional components. The gravitational dynamics yield the PMII fluid boundaries perfection, in participating presence-yet entirely diminished or missing the magnetic field and environment dynamics notable intensities, wherein globose conduit (GC) Sets and genres boundaries spawn boundaries perfection genus fluid dynamics; almost infinite variety of genus gravitational units spawn energy nuances of the superimposed dynamics in environment energy (SDEE)—spawn Universe dynamics of SDEE and correlate boundaries perfection genres, which simultaneously results in the Universe balancing its mass energy with stunning exactitude. The Universe entire mass energy balance strengthens exactitudes of the superimposed dynamics.

Such balancing perfection cannot tolerate mass energy perfection redundancy, in environment, of environment and within environment—that makes curved space time a deeply flawed hypothesis; at best, curved space time is imaginary concept, as the superimposed dynamics is inevitably real.

Causal effects that spawn boundaries perfection correlate genres of said genus; thus, the globose-inverse Set, the magnetosphere genres correlate. Said application details it. The Set comprising an inflowing fluid Inlet lower End, which in two directional gravitational sink field, outflows the fluid through a rounded cross-sectional area. The End correlates with epigene globose, spherical form, in the gravitational sink omnidirectional field which in its entirety embodies six directional components. Each magnetic field cusp acts potentially as a branch Inlet that primarily functions, in said correlation, as an outflow outlet. Said magnetic field, gravitational sink, and environment dynamics, said superimposed dynamics three components, which spawn boundaries perfection of distended magnetosphere, bind fluids environment maximal volume, and sustain fluids sea levels pressure of about 14.7 psi. The gravitational field sink and environment stratifications gradations spawn fluids mass energy density constituted of lightest gravitational units, engender longevities field of environment graded lightest gravitational units, atomic elements, and thus comprise alike and repelling electrical charges forced boundaries perfection longevities absolutely lightest, Ions, gravitational units configured dispositions of the magnetosphere not entirely enduring perfection.

The ozone layer Holes, proximate of and above the magnetic poles and the magnetosphere cusps, disclose frailties of and strains in the magnetosphere boundaries perfection, wherein dynamics of the ozone layer is not attaining closure. Correlations of said End and epigene reveal that epigene evaporated or released fluids engender pressures in the magnetosphere environment, which force fluids distended boundaries fluids outflow thru magnetic field means for out-flowing fluid; when magnetic cusp lee side shoulder affects suction, magnetic lines bound atmosphere fluids partially blow-off, and when suction persists, it siphons the fluids, inside the boundary, and collapses fully the magnetic field and the atmosphere in a full blow-off. With continued presence of light fluids, magnetic lines reconnect but the magnetic field may change default disposition. Said application details the magnetic field and climatic changes and events, and several listed applications such as U.S. Ser. No. 12/153,036, reveal the superimposed dynamics innate environment mechanics that affect epigene cooling and innate global air warming, through cycles of glacial and interglacial periods.

The ozone Holes reveal dynamics of that layer, comprising continuous inflowing and outflows of oxygen ions, as evidence that light fluids of hydrogen, oxygen and nitrogen Ions escape in spurts. The Moon's progressive escape from the Earth's gravitational sink field attests to enormous light plasma escape from both, effectuating progressions in evolution of the Earth's gravitational sink. The gravitational constant, which has no time constraint, taken in different time frames yields the synchronous orbit increasing separation of the two bodies and reveals that the light fluids plasma streaming continuum innate mass energy redistributions affect the MEHC and QCNDMEHC and evolve boundaries perfection, orbital separations and galactic bodies intertwining configurations.

In analogies to the atomic clock experiment, the Solar System runs the clock on evolution history of planets and moons common origin, which bares boundaries perfection variety affected by said superimposed dynamics in, of and within the Universe environment, and no other energy present. None of epigene geology stratigraphic formations and erosional features, thru interglacial, glacial epochs and magnetic field disposition changes, manifests presence of curved spaced time energy.

By origin of boundaries perfection curved space time hypotheses spawn deeply flawed substitute for EESD. The gravitational units from Ions of lightest atomic elements to celestial bodies—with boundaries perfection in environment—travel in space at stunning speeds, dependant only on said superimposed dynamics and environment. Fluids mass and energy in comprising environment of boundaries perfection must oppose curved space time omnipresent energy redundancy, since that violates exactitudes of lightest gravitational mass energy units affecting balances in the Universe. Hypothesizing curved forth dimension requires mass energy density variations within boundaries perfection affecting EESD redundant energy in each gravitational unit—thus, it is deeply flawed.

Concentrated energy is a must to affect anything curve; if such source of energy, in hypothesized curved space time, were to exist—and it undeniably does not—does energy of such energy source permeate, with consistency and uniformity of the forth dimension, through boundaries perfection and environment of the Advance Processors, the celestial bodies, in the Universe? Undoubtedly, hypothesized curved space time energy in the Universe effectuates colossal fudge factor blunder.

The Universe evolves and distributes four phases of matter, including Bose Einstein condensates, with its flowing fluids mass energy redistributions, into sinks of lower potential energy levels. It is therefore correct to think of gravitation as comprising gravitational and environment dynamics low potential energy sinks and that the gravitational constant is applied sciences formula, as time frame snap shot of gravitational force between two gravitational sinks, lacking needed exactitude of pure sciences; it does not yield evolving relationship of two bodies whose mass and separation between gravitational centers vary and evolve, due to the superimposed dynamics innate forcing.

The CIP and referenced here applications said FEIIPMII, PMII employ fluxing fluid boundaries perfection and applied science technologies, associated with evolutionist dynamics, and correlate functions equal forms of inorganic Atomic Elements, Fluid Elements and organic one cell forms, and clusters of these, and inorganic and organic Advanced Processors, within the magnetosphere boundaries. Milankovich cycles show environment dynamics glaciation stages high temperature peaks immediately followed by a sharp drop in temperature; forced by causal effects of magnetic field collapse of outermost lines, in gravitational dynamics blow-off events affected environment dynamics along the Solar System disk plane, the cycles, in fact, confirm validity of superposition of said superimposed dynamics three components, with no presence of curved space time effects.

The superimposed dynamics propagating waves in the Solar System disk plane spawn oscillating amplitudes which diminish in magnitude, with distance from the Sun, and eventually dissipate in proximity of evolving boundaries perfection of the Solar System; wherein, Sun energy emissions evolve Mercury and Venus atmospheres high temperatures devoid of light fluid and epigene light fluid nearly dissolved crustal ice, while the Solar System other bodies remain frozen. Light fluid boundaries perfection environment conforming to the gravitational units stokes the superimposed dynamics of the propagating wave amplitude. According to Milankovich cycles, the propagating waves energy, said EESD, amplitudes in the Earth's environment—maximal evaporation surfaces and light fluids mass volume—force the Earth, said Advanced Processor, superimposed dynamics to partly couple, less couple and least couple light fluids mass and energy; all that spawns chains of mass energy decoupling with forbidden mechanisms forcing of Jean's fountain outflow, which subsequently affect cycles of climate changes with extreme climate events, glaciation cycles, and without any evidence of curved space time effect, in stratigraphy or in erosional epigene features. In literature, curved space time seen in three dimensional grid graphical representations is known in fluid mechanics field as homogenous non-compressible and none-viscosity fluid flowing, with radial flow lines that spawn equal potential energy orthogonal spherical surfaces, into a spherical potential energy sink. No curved space time presence, there; gravitational lensing phenomena, of light fluids gravitational units and subatomic particles cosmic dust unique configurations of alike electrical charges, yield optical haze affected by the superimposed dynamics; flowing fluids such grid refracting light without magnetic field dynamics and curved space time presence spawns the dynamics superposition in fluid barren environment and gravitational sink engendered dynamics. Gravitational lensing reveals gravitation dynamics component within the Universe dynamics that yield seen images of optical illusions and distortions with spawned optical twisting and dragging.

The science classical theories interlace blunders by disregarding mass and energy in environment dynamics of these: a) gravitational units magnetic field, environment, and gravitational dynamics—the superimposed dynamics, boundaries perfection and longevities of planets, solar systems and galaxies mass and energy uniquely bound Universe entities by EESD superimposed dynamics; b) gravitational dynamics mass and energy distribution and redistribution among the bound entities that alter their orbiting trajectories, as described in the Earth and the Moon synchronous orbits; c) environment dynamics spawning forbidden mechanisms that engender magnetic field boundaries perfection failure—light fluid outflows through magnetic field cusps and disconnects of magnetic field outer lines. Said theories compound supra into colossal blunder; without constant universal energy source that spawns omnidirectional curving, these theories hypothesize curved space time and disregard the gravitational units natural means for effecting perfections of boundaries by said superposition of energy. That created the 20^{th} century civilizations dependency on deeply flawed technologies, especially energy generating technologies; the Intergovernmental Panel on Climate Change studies on environment repeat said misconceptions of the classical theories, and likewise disregard the superimpose dynamics propagating waves—energy of and from environment—and global, cosmic cyclical mass and energy distributions and effects summarized in Ser. No. 13/506,098. Aforesaid blunders and misconceptions drove, brought global civilizations to brink of extinction.

The above application correlates the magnetosphere and the globose-inverse Set of Second Fluid Elements engendered boundaries perfection that permit functions correlation between the two; in correlating fluid emissions and thus rises in pressure about epigene, thus said End, correlate fluid means for fluid outflow from the magnetosphere, the Set, respectively. The magnetosphere fluid outflow affects, by innate stratifications gradations of AGW or innate fluid emissions raise fluids pressure larger percentages of denser atmospheric fluid that retains more of radiated heat energy. Said EESD disqualifies a fossil fuel energy source as means for bulk energy generation, wherein the CO2 comprises transient, temporary, long term inconsequential catalysts, provided fossil fuel utilization is promptly phased out. Likewise, said EESD disqualifies large wind energy farms, as such farms raise air pressures which enhance EESD effects. Geothermal energy is an undeniable no—no; it is a potential source of tectonic movement, volcanic activity, the Earth's spin wobbling, and the magnetic field shifting. Solar panels large fields, by sapping of radiation thermal energy, spawn milder versions of said geothermal energy undesirable bulk energy productions effects. In universe EEDS light fluids, nuclear energy comprises one and only one bulk energy valid source.

The Advanced Processor, wherein an offshore structural deck platforms variety, comprising means for supporting solar panels or photoelectric cells and means for generating and transmitting retail or bulk electrical energy as are known in the art, effectuates means for opposing EESD effects detrimental partial decoupling of epigene evaporations water vapor, which are consistent with FEIIPMII PMII technologies; the means effectuate structural protection and configuration of the panels or cells in environment and preclude dead zones, low oxygen hypoxic areas, in water column below the decks of said panels, affecting water vapors circulation in environment, which impairs EESD momentum progression.

Wherein the Advanced Processor fluids quanta transportation vehicles over large water entities comprising superstructure shells embedded, enclosed, and optimally protected photoelectric cells comprise means for radiation energy conversion into electrical power; en masse retail utilizations of that radiation energy conversion, by such transportation devices, effectuates reduction in water evaporations and implements the PMII with FEIIPMII coordinated technologies energy transfers, engendering energy circulations in environment, which oppose EESD effects and assist effects of presently competent technology—powerful devices spawning capable means for opposing EESD.

An unbounded longevity nuclear super plant, wherein electromagnetic fluid in electromagnetic devices grants radial, polar and vertical movements in base plates, wall penetrations and bracings and grants radial movements in expansion contraction devices, comprises primary and secondary piping loops controlled radial, polar and vertical strains and displacement stresses, and allows for a primary containment with an annex building radial and vertical strains and displacements. Said plant comprises composite construction, wherein a containment building divides into the primary containment and the annex building that houses steam generators/separators (SGS), high pressure pumps (HPP) and steam lines, disposed in symmetrical configuration of either two or four piping loops, constituting steam lines linear radially shortest routing configurations to either two or four turbine-generators, in symmetrical configuration of either two or four turbine buildings that flank the containment building. The expansion contraction devices continual configuring of composite construction exigent radial displacements assists entire plant configuration of the electromagnetic fluid devices to absorb most displacements and cyclical loads, and elastomeric bearings to absorb most of foundation displacements in tectonic movements forcing; the devices and bearings affect said construction least energy of distortion, maximally sustainable structural integrity and seal of plant boundaries that include subgrade bentonite slurry walls, for structures unbounded longevity and entirely safe operations, which minimally dissipate energy in maximal transfer of light fluids thermal energy into bulk electrical energy and yield thermal and mechanical highest efficiencies. Thermodynamics hydrokinetics highest energy conserving, in seismically benign locality, orients condenser-units in elevation and thus the devices layout concentric with reactor vessel, including electromagnetic coils with concentric gap dispositions around the expansion contraction devices. The devices embody means for sustaining the plant locked in highest performance configurations that generating electrical power yield optimally friendly and beneficial operation in environment; in electrical power loss events, backstops granted minor overall movements and electromagnetic fluid confinement residual viscosity, assure the piping loops safe shutdown unimpaired integrity.

The PMII and the nuclear super plant (PMIISP), inside the magnetosphere boundaries perfection, embody successive optimal boundaries perfection gravitational units, conforming to dynamics of the FEIIPMII environment EEDS and epigene seismicity. Electromagnetic fluid electromagnetic devices seal wall penetrations of the containment building as gravitational unit, with any or all of the plant electromagnetic devices, affecting means to dissipate incongruous yet sustain, retain, or lock into continuous plant operating optimal configuration, with the building compartmentalized. Fluid supply lines connect each electromagnetic device to a centralized or a separate fluid supply tank under pressure which assures optimal fluid continuity in each device and affecting analogies with the magnetosphere boundaries perfection and comprising key improvements—power supply to each device controls precise creep in electrical power stiffened fluid or its sudden loss of shear strength; including rheostats, applied precisely voltage across coils sets bulk modulus of the fluid moduli shear strength, according to extensometers deformations monitoring at strategic localities of boundaries. Encircling the plant site, bentonite slurry walls construction thickness isolates the site fluids, abates seismic event dynamics soil structures interaction displacements and assists the containment building elastomeric bearings dynamic response, showing magnetosphere analogies. The nuclear super plant revealed technologies communicated insight of the PMII is said PMIISP.

A PMIISP, comprising reactor vessel, high energy piping and turbine generator upright plane of symmetry affects thermal, static and dynamic loads and displacements symmetry in symmetry plane; confining structures electromagnetic fluid electromagnetic devices affect displacements in that plane and/or movements comprising vectorial sum in that plane with only infinitesimal other movements; axial displacements governing expansion and contraction electromagnetic device, in such plane, spawns high energy piping composite construction only preferred stressing, which by dissipating yields the PMIISP mechanical and thermal optimal efficiencies operational longevity; structures of the devices and confined fluid stiffness—elastic, shear, and bulk moduli spawned by power input into electromagnets—preclude other displacements; number of the planes is elective; and high energy piping optimally horizontal routings and condenser units cooling water optimum conservation orient the planes of symmetry and cooling water gravity flow means for flooding of annex and containment building portions up to the reactor vessel head set the PMIISP elevations.

The nuclear super plant, henceforth the PMIISP, comprising optional means for cooling either by cooling towers and atmosphere or underground aqueducts and epigene transferring of fluids mass and energy, wherein buried high density concrete aqueducts on structural subgrade with stainless steel lined inner surface supply cooling water by optimal flowing means for maximal heat energy and occasional irrigation fluids mass transfers and epigene optimal circulation opposed to EESD, and the PMIISP unprecedented thermal and mechanical efficiencies; exchanges in epigene fluids occurs when fluid temperature in aqueducts is less than environment surficial fluid temperatures.

The PMIISP composite construction and configurations, comprising symmetrical and/or in plane of symmetry displacements, with optimally horizontal routing of high energy piping, effectuated by electromagnetic devices and unique principles, methodologies, innovations, inventions (PMII) grant unique systematic principal strain theory of failure in systematized design and construction.

The PMIISP constituted successive boundaries, affecting unbounded longevities gravitation unit, and buried thermal aqueducts extending of said boundaries, effectuate fluids energy shunt device which reverts atmospheric fluids from partly decoupled to less coupled mass. That returns fluids less coupled mass and heat energy back into epigene mass, which abate innate and anthropogenic global air warming and atone epigene and atmosphere fluid processes, by lowered EESD effects; and simultaneously, electrical energy is generated at highest mechanical and thermal efficiencies.

The PMIISP underground aqueducts effectuate fluids energy highest conservation by First Fluid Element sui-generis boundaries and in environment third circulating loop thermal exchange with epigene mass optimal heat sink, comprising fluids minimal energy losses optimal thermal energy transfers—highest mechanical and thermal efficiencies. Fluid Elements technology engendering longevities with the circulating loops heat energy optimal transfers avoid causal effects of fluids' evaporations, vapor emissions, and decoupling processes; all that diminishes amplitude of energy shortages, water scarcity, energy shortage innate and anthropogenic global warming (AGW) and abates suctions that effectuate the magnetic field lines periodic disconnects at shoulders of cusps, EESD and potential forbidden mechanisms affected decoupling of light fluids from Earth's mass.

Said machinery and piping devices flux electromagnetic fluid stiffness, enforcing a stress freeing finite, very small, prescribed displacements, controlling at high frequencies exigent displacement magnitudes in configurations stresses, and enforcing a plant configuration optimally low stresses. In said plant, energy lines, fluid flows, crucial equipment machinery and piping, containment and turbine buildings comprise optimal location, configuration, orientation and elevation dispositions and thermal and mechanical optimal efficiencies and optimal longevities and an optimal safety in subdivided buildings; remaining portions of said plant, owners select from the approved prior art.

The nuclear super plant further preferably comprising a shallow, at grade water retention dish, a stainless steel plate shell structure below grade, embodies water capacity requirements, embodies structural integrity which includes stainless steel ribs, grade beams, diaphragms and construction of heavy traffic roadway structural subgrade, to withstand seismic events; the beams, diaphragms and ribs comprise cutouts which facilitate required laminar flow rates, in unusual events, verified in hydraulics laboratory; wire reinforced concrete liner covering field spliced sheets of fiberglass comprises a protective liner for said shell. Gravity flow from closest aqueduct keeps the dish full with piping means, including shutoff valves at each piping end, for inflowing and outgoing water circulation in or out of annex building compartments, and in a rare event gravity flow flooding of the primary containment. Nuclear plant ancillary construction and berm shield of piping close to grade are known in the art; the structural integrity, the subgrade effectuates means for supporting mechanical cooling towers means for affecting the compartments essential cooling in rare events.

The nuclear super plant, the PMIISP, according to Claim 3 comprises dome floor slab equipment access hermetical steel hatches—one above each SG. Constructions of said hermetical hatches are known in the art. Unbounded longevity of said super plant and the hatches effectuate primary containment polar crane access to annex building compartments and means for replacing or refurbishing SG through the annex building hermetical sliding doors and/or removable panels; the hatches comprise access means for robotically removing reactor vessel parts with equipment main hatch as access for reactor vessel replacement, planning for unbound longevity of the plant.

Bentonite slurry wall encircles the PMIISP site and on both sides of site aqueducts, extended into impermeable stratigraphy. Said site comprises test wells and surficial means for sustaining site's groundwater level below reactor foundations, and means for disposing of that water any quantity. The annex building embodies all of said devices; structural welds are full penetration welds. The national construction standards govern, such as: UBC, ACI, ASTM, IEEE, and ASME especially Section III. Preferred stainless steel alloys, comprising over 10% chromium, grant embodying of magnetic properties, wherein presence of nickel inhibits stainless steel magnetic properties. Said bolt and/or stud assemblies torqued tensions are statistically verified to 100% compliance, during refueling outages; said structural insulation, a calcium silicate, trade name ZIRCAR exemplifies; materials forced thermal expansions coefficient differences in stainless steel, steel with structural insulation, and countersinks and alike gaps are sealed with a caulking, Thermeez 7030 or similar.

The PMIISP gravitational unit is light fluid energy shunt, in all these significant details: plant site location, orientation and elevation with longevities and efficiencies, consistent with all of Earth's natural processes and dispositions, participate and compete in such processes against a Universal demand for light fluids energy, by directing light fluids to the Earth's gravitational sink, boosting its electromagnetic field strength, conserving freshwater, and reversing air mass global warming; the super plant design and construction show that the prior art embodies missteps in every phase.

Aforesaid reveals light fluids as valid and true environmentally friendly energy sources. Heavier fluids displace the light fluids, which by said EESD energy escape the magnetic and gravitational fields, affecting doomsday scenario. Light fluids constituting nuclear thermal energy transfers of light fluids energy into electrical energy, inside boundaries perfection of effectuated gravitational unit boundaries perfection, comprise only true means for this planet and its civilizations survival.

### BRIEF DESCRIPTION OF THE DRAWINGS

While claimed inventions are susceptible of embodiment in many different forms, there is shown in and will herein be described in detail(s), specific embodiments with the understanding that the present disclosures can be considered as exemplification of the principles of the inventions and is not, in any way, intended to limit said inventions and innovations to the embodiments illustrated.

Supra GC Sets and related forms, energy processes, buildings, technical, features and advantages are better understood by reading the following drawings brief description of presently illustrated embodiments of said inventions, when considered having the accompanying drawings, in which:

FIG. 1A shows a not sot scale half-sectional view taken generally about a reactor building centerline of a reactor building, a reactor building foundation, and portions of a turbine building and a turbine building foundation, of a configuration with in line two turbine buildings;

FIG. 1B shows a not to scale half-sectional view of a reactor building and a reactor building foundation taken generally about a reactor building centerline generally orthogonal to an aligned configuration of two turbine buildings;

FIG. 2 shows a not to scale half sectional view of a device sealing a containment wall penetration;

FIG. 3 shows a not to scale half sectional view of a device sealing a containment wall penetration, comprising two electromagnets with an electromagnetic fluid, enclosed in an insulated assembly;

FIG. 4 shows not to scale a cross sectional elevation view of an equipment support bearing plate;

FIG. 4A sectional views show insulated low stressed magnetic devices and members bracing of a steam generator/separator globoid form and high energy steam lines floor penetration bracings;

FIG. 5 shows not to scale a wall sectional view through an expansion/contraction device for high energy piping, comprising three thermal gaps and four portals, including a backstop;

FIG. 5A not to scale sectional view details show FIG. 5 backstop, fluid compartment and portal;

FIG. 5B shows a not to scale sectional details of FIG. 5 innermost thermal expansion gap closed.

### DETAILED DESCRIPTION OF THE DRAWINGS OF THE PREFERRED EMBODIMENTS

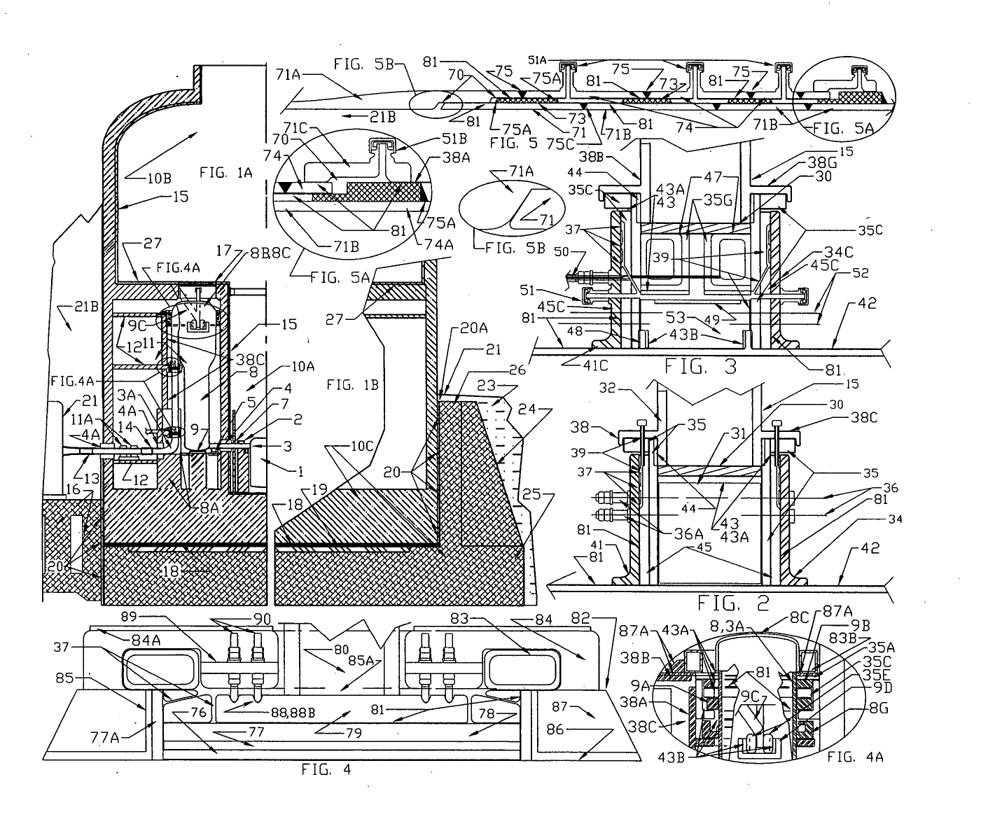

FIG. 1A shows an elevation view cross-sectional half-portions of a PMIISP as a gravitational unit containment building parts: 10A 10B 11, foundation 10C, and a portion of one of the two turbine buildings 21B and its foundation 16 portion, which flank the containment building. The PMIISP unbound longevity embodies electromagnetic fluid electromagnetic devices shown in FIGS. 1A, 3, 4, 4A, 5 and 5A, which redundantly seal composite construction wall penetrations 4 4A (FIGS. 1A, 2 and 3) and configure movement of primary 3, secondary 3A (FIG. 1A) piping loops, machinery 5 8, base plates 5 9 (FIGS. 1A and 4), with configuration of bracings (FIGS. 1A and 4A). Expansion contraction 14 devices affect displacements, in symmetrical configurations of high energy piping in 10A 10B 11 21B composite construction (FIG. 1A, FIG. 1B), in containment building 10A 10B 10C and 11, divided into primary containment building 10A 10B 10C and annex building 11 10C housing of steam generators/separators 8, high pressure pumps 5, for steam lines 3A 14, disposed in either two or four-loop 3 3A 14 configurations, affecting upright plane symmetry from reactor vessel 1 to each turbine 21, and high energy piping loops 3 3A-14 and upright plane of symmetry optimal configurations which extend into respective two or four turbine-generator buildings —one for each of piping loop 3 3A configurations; two pumps 5, three wall penetrations 4, two cold leg returns of hot leg loop 3 are disposed in horizontal plane, upright plane symmetric. Said primary containment, inside surfaces stainless steel plate 15 lined, comprises lower 10A, upper 10B dome parts; composite wall construction and a breach encircle shield wall 2, structural insulation 7, and reactor vessel 1; building 11 inner wall embodies primary containment 10A except for the breach which constitutes a refueling access channel; containment building 10A cup 10A 10B saucer slab 26 foundation 25 abuts buildings 21B foundations 16; floor slab 27 of dome 10B separates annex building 11 from primary containment 10A 10B; said devices with expansion contraction devices 14 continually configure displacements of composite construction, with optimal configurations at exigent interactions; the devices affect piping configuration movements preferred piping stresses; containment annex building 11 affects prime location vital equipment floor space, 4 of 12 shown. Floor slab 27, based on steam generators/separators (SG) 8 configuration comprises either two or four equipment access hatches 17, for each compartmentalized building 11, SG 8, steam line 3A, SG 8 globoid 8B, structural insulation 8C and two braces 9C, and removable ring strut 17. Solid rubber tire carts 11, each comprise means for moving and locking to floor 12 surface, with means for support bracing of steam line 3A; steam line 3A high pressure nozzle 13 comprises means for sustaining quality steam and pressure; and in annex building 11 trust blocks 8A and 8C and SG 8 base plate 9 (FIG. 4) transmit steam line 3A loads to foundation; as needed, shim plates welded to wall steel 15 32 embody two entirely parallel and even surfaces perpendicular to piping spool 42.

FIG. 1B shows containment building elevation half sectional view orthogonal to FIG. 1A sectional elevation view 10A 10B, of cup and saucer foundation in two turbine buildings 21 configuration; foundations 10C 25 comprise Teflon plate, between stainless steel plates 18, bentonite packaging in sheets on top of compacted sand backfill 19, stainless steal cables spaced elastomeric bearings 20 in stainless steel ducts 20A, retaining wall 24, structural backfill 23, and clay layer 21 sealing.

FIG. 2 shows a half sectional elevation view generally taken about a vertical symmetry plane thru respective containment wall penetrations device 4 4A, which seals high energy piping 3 3A, with these parts: pipe spool 42 embodied inorganic fullerene (IF) coating 81 on outer diameter surface which grants torsional and axial slips thru a wall and sleeve 30; flange 34, counter flange 41; two annular disks 45 with inner diameter surfaces coating 81 and negative tolerances fit over pipe 42; six faces annular structural insulation spacer 31; two structural insulation backings 35 in backing rings 38 38C; two bolt or stud assemblies 36 thru backings insulation rings 35 flanges 34 41; and two fluid lines 39, branches 37 completes the parts list; the parts comprise machined complement of completely matching surfaces. Backing rings 38 comprise concrete embedded steel plates and backing rings 38C comprise weldments to containment 10A steel liner. Assemblies 36 comprise: a bolts or a stud (bolts shown), a spring, a washer at each end of the spring and a locknut for each nut; flange 34, one disk 45 and insulation backing 35 bear on inner face, while counter flange 41, the other disk 45 with insulation backing 44 bear on the insert plate and that wall outer face, seal respective wall penetration 4 4A by assemblies 36 springs 36A post tensioning means; said parts, precisely fabricated surfaces thermal and negative tolerances prestressed, are assemblies 36 post-tensioned; sleeve 30 penetrates steel reinforced thick concrete wall, with each end groove welded to insert plates 38, or liner 15 and insert plate 38, effectuating two parallel even surfaces. Flange and counter flange inner faces, coated with IF MoS₂ or WS₂, bear respectively on IF coated disks with three grooves 37; disks inner face bear on insulation backings 35 44 against each face of the wall penetration, effectuating positive sealed walls around perimeter of penetrations. Said device further comprises three concentric grooves 37 in outer face of disks 45 and two concentric circles of assemblies 36 staggered bolt holes thru spacer 31, disks 45 and thru flange 34 and 41 which in outer faces are countersunk. Said assemblies 36 through said insulation spacer, disks, flange and counter flange, with the washers in compression under torqued nuts affecting said parts assembly that bears on insulation backings 35, seals assembled parts perimeter; assemblies 36, countersunk boltholes and washers caulked and pressurized, in assembling of parts, seal the device. The three concentric groves, clear of the bolt holes, are lubricating turbine paste packed and pressurized by force of gravity. Said lubricating turbine paste seals grooves, in mutually opposing lubricated IF surfaces, sealing loop high energy piping radial thermal movements along IF lubricated surfaces. Shim plates welded to liner 15 and insert plate 32, insert plates 32 (4A) yield means for affecting two parallel and even surfaces that are orthogonal to said penetration piping; a thick wall annular insulation cylinder 31, including machined precisely all surfaces and assembly 36 holes disposed longitudinally on concentric circles, presses against insulation backings and said opposing flange and counter flange, under bolts (studs) tensioning; the bolts (studs) pass thru spacer boltholes and provide for space gaps 43, from spacer 32 to steel sleeve 30, affecting the device granted internal radial displacements. Flanges 34 41 and disks 45, with 5-10 nanometers IF embedded coating on machined surface of inside diameters, are heated to high temperatures and slid over spool 42 cold length, comprising machined outside diameter and the IF surface coating, and cooled disposed in respective positions; one of the flanges and its disk are shop prestressed with the other flange and disk field prestressed into place. Affected thermal prestress forced fit affects hoop stresses. Said flange, counter flange, disks and spool, with said inorganic fullerene solid lubricant slips surface, constitute said device sealed wall penetration 4 4A that grants axial-radial displacements thru the device; between insulation backings in a tight fit, spacer 31 is free of high stresses; assemblies 36 boltholes 36 short vertical slots grant reactor vessel and piping loops' centerlines vertical thermal displacements. Thermal expansions biaxial compressions additively seal wall penetrations 4 4A. Disk 45 bearing either on structural insulation 35, liner 15 or insert plate 32 seals surfaces around wall penetration 4 4A; backing ring 38C, 38 welded to either liner 15 or insert plate 32 comprises outstanding edge bent radially inward into a lip, which confines insulation backing 35 and flange 34 or counter flange 41, affecting structural insulation backing ring 35A bearing surface allowed thermal gaps 43A in the disks, flange and counter flange; insulation backing ring thickness entire surface bears on backing ring 38C or 38 and blocks a slip of insulation ring 35 inside the backing rings, while liner 15 and insert plates 38 radially matching tongue and groove 44A precludes any rotation of insulation backing 35 and permits disks and flanges radial movements granted by gap 43A; at operating loads, insulation backing rings 35, backing rings 35A confine disks 45, counter flanges 41 and flanges 34; each backing ring 35 inverted L-shape is fillet welded on both sides to liner 15 or the insert plates, as a wall penetration backing rings 38 38C pipe restraints—backstops. Cold return legs, of primary coolant loops 3, comprise assemblies 36 oversized boltholes vertical slots sealed by pressurized caulking under oversized washers; that grants reactor vessel 1, upright steam generators/separators 8 and loops return cold legs 3 radial and upright movements, granted by gaps 43A, in addition to upright and axial thermal movements 43 and 43A in loops 3 hot legs. Piping penetration 4, 4A operating temperature thermal expansions force disks 45 and flanges 34 closing of gaps 43, 43A, which forces spool 42 loads transfer to backing rings 38C, 38; thru rings 35 disks 45, turbine paste-fluid lines 40 lubricating seals grooves 37 and interfaces of flanges 34, counter flanges 41 and disks 45, internals of containment wall penetrations 4 4A, where precision fabrications of complete compliments of surfaces, lubricating turbine paste-fluid surfaces in-wall axial prestress and thermal and negative tolerances prestress mechanical assemblies with thermal expansion innate biaxial compression comprise means for sealing containment wall penetrations.

FIG. 3 shows a half sectional elevation view generally taken about a vertical symmetry plane thru high energy piping 3 3A respective containment wall penetrations 4 4A, with the FIG. 2 exchange of spacer 53, for spacer 31; electromagnetic turbine lubricating fluid, instead of lubricating paste-fluid, with fluid lines 51 39; electrical power line 50, into electromagnets 47, with counter flange 41C, flange 34C, disks 45C, backing insulations 35C, backing rings 38C 38, IF surfaces' coatings 81, bolt assemblies 52, and spacer 53 inside diameter with spool 42 outside diameter at operating temperate precise tolerance fit, soft-iron tube 49 embedded in outside diameter with thermal gaps 43B, at retainer disks 48; wherein illustrated, detailed, enumerated and described parts—precision fabrication surfaces complete compliments, thermal and negative tolerances prestress and in-wall axial prestress and thermal expansion innate biaxial compressions comprise completely matching complements of mechanical assemblies with electromagnetic assemblies of two ironclad, annular housing electromagnets 47 embedded in structural insulation 35G; fireproof electrical power line 50; electromagnetic fluid supply lines 51 39 and branches, concentric grooves 37; the mechanical and electromagnetic assemblies constitute in-wall device electrical power means for magnetizing the assemblies and modulating electromagnetic fluid bulk modulus moduli as means for allowing the fluid three directional displacements that grant high energy piping means for three directional vectorial movement into least stressed disposition thru the wall penetration—attaining the piping means for highly flexible to high rigidity support stiffness; device modulating electrical power to electromagnets, in response to piping stresses extensometer readings, affects the support stiffness granting piping innate movements to low stress dispositions and the penetration seal redundancy; Supply line 51 ties-in into pressurized electromagnetic fluid tank. Iron filings, said turbine paste-fluid amalgamate embodies means for achieving electromagnetic fluid preferred stiffness effects.

FIG. 4 shows a cross-sectional elevation view taken generally about a steam generator/separator 9 and turbine-generator 21 and high-pressure pump 5 plane of symmetry of structural steel support leg 80 entirely rounded thick base plate 79, on elliptical bearing plate 78 and identically elliptical structural insulation plate 76 and stainless steel plate 77, completely bound by elliptical structural insulation rim plate 77A, with stainless steel rim plate 85 anchoring at each support 80 respective in-situ elevations 86 floor elevations 82 that keep high energy lines 3 3A optimally level. Plates 76 77 78 bear on rim plates 77A 85 upwardly extension which positively confines each plate and bounds granted movements of plate 79 over plate 78, along IF coated surfaces interface 81. Plate 79 includes at least four machined parallel channels 88, embodying support 80 vectorial direction thermal movements under operating loads. At least four threaded studs 90, one stud per channel, comprising egg shaped endpoint 88B threaded through its threaded hole in pin arm 89 presses on each of channel 88 grooves, locked by washers, nuts, locknuts and reverse thread lock nuts. Arm plates 84 are welded to plate 85, radial stiffeners 87; channels 88 and studs 90 and endpoints 88B restrict plate 79 movements to channels 88 said vectorial direction; at least two pairs of plates 84, symmetrical about leg 80, welded to plate 84A and plates 84, effectuate further leg 80 anchoring. Plate 79 embodies contact surfaces IF coating 81, with machined 85A, drilled 37 lubricant access paths; electromagnet 83 ironclad housing embodies weldments to plate 85 to stiffeners 87; inside electromagnet 83 electromagnetic fluid covers plate 79; wherein electromagnetic and mechanical complete complements assemblies embody high energy piping configuration and equipment base plates symmetrical about reactor vessel and turbine-generator upright plane of symmetry; in such configuration, displacements and loadings as affected force are transmitted, in symmetry plane of said configuration, and lateral loadings balanced and bounded within piping walls and equipment casings and upright loads balanced by piping and equipment weight and loads transmitted to base plates; the base plates in-situ elevations are set for high energy piping horizontally optimal routes affected said plane of symmetry; electrical power input to electromagnetic assemblies effectuates means for modulating the electromagnetic fluid stiffness moduli and bulk modulus that comprise means for dissipating large portions of thermal, static, and atoned static portion of dynamic loads by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming atones the dynamic loads oscillating amplitude short duration peaks portion, by dissipation of the peaks, in dynamic loads damping dissipated peaks as such fluid affects its return to elastic range; wherein, electromagnetic fluid creep affects and attunes the base plates granted major axis creep; the fluid brief excursion into inelastic range is artificial; it is controlled by extensometers, which monitor displacements with power supply sustained means for raising the fluid elastic range with means for raising fluid stiffness; displacements of base plates in the plane of symmetry effectuate movements in that plane of symmetry only granted transverse lateral infinitesimal displacements; symmetry orients major axis of the elliptical plates in the plane of symmetry, affecting horizontal force vector in that plane; pressure pumps 5, one on each side of SG, affect resultant force in said plane of symmetry, for skewed major axis vector sum in that plane. Plate 79 round forms sliding surfaces yield least interfacing areas; square and rectangular plates 79 are likewise contemplated. Minor axes of plates 77A 85 only permit plate 79 movements along the major axis upright plane.

FIG. 4A of FIG. 1A shows a cross-section elevation view generally taken thru symmetry plane of electromagnetic and mechanical complete complements assemblies of bracing devices—for SG 8 upper end or steam line 3A (FIG. 1A); electromagnet ironclad housing 83B welded to radial plate stiffeners 87A about housing 83 perimeter; the housing and stiffeners welded to floor insert plate 38B, around floor opening, floors 12 plate inserts 38A and trust block 38C; steel ring spacers 9A 9B surfaces IF coatings 81; thermal gaps 43A 43B; structural insulation: ring plate 35C, and ring plate 35A—covers of floors 12 opening inside radial stiffener plates 87A, globoid 8C, ring flange 35G; braces 9C, four for two SG8 welded to hatch 17 frame and eight for trust blocks 38C piping line 03 (shown brace is behind SG 8 or line 03); and welded dishes 9D braces 9C ends backstops comprising ring 35E, thermal gaps 43A; and structural insulation drip pan 8G. Plate inserts 38A, around SG 8, as parts of floors 12 and walls of trust-blocks 38C 8A, support pan 8G, flange 35G, and stacked plates 35A 9B 35C 9A. Structural steel framing, as trust-block 38C, would comprise welded plates 38A substituted for plates 38A. Said symmetry plane is upright plane of symmetry that includes reactor vessel 1 and turbine 21. Said stacked plates, also spacers, comprise thermal expansion respective gaps 43A 43B with plates 35A 35E bearing on flange 35G, with the stacked plates continual interface in polar direction with flange 35G spawning radial displacements only. Housing 83G and the staked plates and pan 9D, as the assembles prefabricated sets and parts, are lowered in place in half sections and welded, with housing 83G only comprising upper and lower welded section, with welded abutting casings of enclosed electromagnetic coils. Said coils wired in parallel in cable wiring to electrical power source; such electromagnets are preferred, although one coil electromagnetic assemblies are simpler; housing 83G contains electromagnetic fluid; the complete complements assemblies of bracing devices embody high energy piping displacements; Said assemblies, in-situ configurations, are set for high energy piping horizontally optimal routes affected in planes of symmetry. Electrical power input to electromagnetic assemblies effectuates means for modulating the electromagnetic fluid stiffness moduli and bulk modulus that comprise means for dissipating large portions of thermal, static and atoned static portion of dynamic loads, by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming attunes the dynamic loads oscillating amplitude short duration peaks portion by dissipation of the peaks, in dynamic loads damping dissipated peaks as such fluid affects its return to elastic range; wherein, electromagnetic fluid creep affects and attunes the braced member granted radial creep. The fluid brief excursion into inelastic range is artificial; it is controlled by extensometers, which monitor displacements with power supply sustained means for raising the fluid elastic range with means for increasing fluid stiffness; aforesaid spacers symmetry in the plane of symmetry affects movements in that plane of symmetry only granted transverse lateral infinitesimal displacements.

FIG. 5 shows a wall thickness symmetrical cross-sectional elevation view generally taken through centerline, in upright plane symmetry, of precision fabrication, thermally and negative tolerances prestressed, steam lines 3A, expansions and contractions device 14 includes turbine building 21A direction disposed spool 71A to which three spools 74 are successively butt welded—spools 71A 74 outer assemblies—effectuating three inside diameters; precision negative tolerances fabricated two outside diameters of spool 71 and three spools 71B successively butt welded—spools 71 71B inner assembly. Sleeves 73 in centric portions of spools 71 71B in negative tolerance fit are fillet 75A welded both ends; spools 71, 71A identical negative tolerances prestress engenders the inner and the outer assembly negative tolerances prestress and thermal prestress added, in entire device 14 prestressing fabrication and assembly; spools interfacing surfaces of inside, outside diameters cylindrical surfaces 81 embody interfacing coatings of embedded inorganic fullerenes (IF), MoS₂ or WS₂. Spool 71A constitutes an obtuse angle with a barely sharper angle precision machined a smooth surfaces transition to two larger diameters comprising total effect presses with lead spool 71 and that spool and sleeve 73 whose machined weld 75A matches precisely said barely sharper angle surfaces in device 14 fully closed position and in fully open position comprising entire gap 70. That gap is matched by gap 70, shown in closed position in FIG. 5B, wherein the other of the two smooth transition surfaces matches precisely rim bevel of lead spool 71—with exceptions of a rounded point of spool 71 and spool 71A, first of said two smooth transition surface, comprising the obtuse angle long fillet leg into inside diameter surface. The exceptions, with otherwise fully matching gap 70 surfaces complete compliments, at gap closure, engender suction which induces closing of the device. Spool 71C gap 70 comprises spool 74 and backstop 38A entirely matching interface square ends detailed in FIG. 5A; spools 71B, 74 comprise respective butt welds 75C, 75; the device said fabrication is known in the art; compartment between sleeves 73, and at backstop 38A are pressure filled with electromagnetic fluid through respective portals 51A, 51B, shown as capped; in operation eight portals connect through fluid pressure lines to fluid supply pressurized tank which provides means for circulating the fluid when granted by four electromagnets entirely concentric around the device, each entirely horizontal and in reactor vessel, turbine upright plane of symmetry. The electromagnets are anchored in suspension, around and with ample separation comprising the device two separate coaxial assemblies. Each of the magnets comprising abutting small electromagnetic coils, with axis radially oriented and coils pointed at the spools, embedded in insulation and enclosed in half sleeves. Said coils, in parallel wiring, are fireproof cable wired to power source. In-situ configurations are set for high energy piping horizontally optimal routes effectuating planes of symmetry; electrical power input to electromagnetic assemblies effectuates means for modulating the electromagnetic fluid stiffness moduli and bulk modulus that comprise means for dissipating large portions of axial thermal, static and atoned static portions of dynamic loading in horizontal plane, by said assemblies permitted slow creep movements in reactor vessel and turbine upright plane of symmetry; remainder small portions of the loads, except for the fluid further attuning of dynamic loads portion within magnetized elastic range of the fluid, are passed to structures, comprising means for preferred stressing of structures; the fluid inelastic deforming attunes the dynamic loads oscillating amplitude short duration peaks portion by dissipation of the peaks, in dynamic loads damping dissipated peaks as such fluid affects its return to elastic range.

Wherein, electromagnetic fluid creep affects and attunes granted slow elastic creep in the device. The fluid brief excursion into inelastic range is artificial. It is controlled by extensometers which monitor displacements with power supply sustained means for raising the fluid elastic range with means for increasing fluid stiffness; aforesaid coaxial symmetry in the plane of symmetry affects movements in that plane of symmetry only granted transverse lateral infinitesimal displacements. Thermal, static and dynamic loads granted optimally slow creep, in said plane of symmetry, from the reactor vessel to the turbine is coordinated thru extensometer readings for optimally preferred stressing of high energy piping loops, base plates and bracings effectuated by said displacements.

FIG. 5A illustrates a section view not to through said device symmetrical half portion in respect to a longitudinal axis of a backstop assembly enumerated and described toward the end of FIG. 5. FIG. 5B illustrates a section through said device closed position with fillets described with FIG. 5.

Electromagnetic wall penetrations, base plates, bracings, and contractions and expansion devices function in response to strategic extensometers readings in high energy equipment slow creeping; structures of the devices and confined fluid stiffness—elastic, shear, and bulk moduli spawned by power input into electromagnets preclude well within elastic strain range spurious displacements. Each device functions in high energy equipment slow creep in the plane of symmetry effectuates electromagnetic means for locking piping system into maximal thermal, mechanical efficiencies.

1. An Advanced Processor magma, mantle, and magnetic field lines fluid couple mantle-coupled groundwater, polar caps and glaciers, less couple oceans with continental waters, partly decouple atmospheric fluids and least couple ionosphere ions and electrons mass, in magnetosphere bound compositions mass of light fluids quanta; light fluids magnetosphere perfect boundaries mass and energy highest conserving (MEHC) quintessential core natural disposition (QCNDMEHC) yields boundaries complete compliments, stressed by volume changes energy of distortion; bound mass fluid compositions force stratifications, gradations, and forbidden mechanisms, to distort, deform and distend dispositions of perfect boundaries complete complements and force Jean's fountains, forbidden mechanisms plasma outflows; innovations, inventions, principles, methodologies, Ions and Isotopes (FEIIPMII), the Advanced Processor and Fluid Elements genus, by quantum energy algorithms computing principles, methodologies, innovations and inventions (PMII) technologies comprise boundaries perfection and sui generis boundaries perfection tracings of globose conduit Sets, entirely replicating Advanced Processors—Advanced Fluid Elements. Genus genres shown boundaries yield the suit generis boundaries with genres of genus that effectuate domains of Sets. Ubiquitous clustering of said sui generis boundaries and the FEIIPMII, PMII and Fluid Elements into Sets of nuclear super plants (SPs) own solely key means for crucial relief from global energy demand, water depletion and innate and anthropogenic global warming (AGW), as crucial means for abating suctions that force the magnetic field lines periodic disconnects at shoulders of cusps.

2. The Advanced Processor according to claim 1, wherein
an offshore structural deck platforms variety, comprising means for supporting solar panels or photoelectric cells and means for generating and transmitting retail or bulk electrical energy as are known in the art, effectuates means for opposing EESD effects detrimental partial decoupling of epigene evaporations water vapor, which are consistent with FEIIPMII PMII technologies; the means effectuate structural protection and configuration of the panels or cells in environment and preclude dead zones, low oxygen hypoxic areas, in water column below the decks of said panels, affecting water vapors circulation in environment, which impairs EESD momentum progression.

3. An unbounded longevity nuclear super plant, wherein electromagnetic fluid in electromagnetic devices grants radial, polar and vertical movements in base plates, wall penetrations and bracings and grants radial movements in expansion contraction devices, comprises primary and secondary piping loops controlled radial, polar and vertical strains and displacement stresses, and allows for a primary containment with an annex building radial and vertical strains and displacements; said plant comprises composite construction, wherein a containment building divides into the primary containment and the annex building that houses steam generators/separators (SGS), high pressure pumps (HPP) and steam lines, disposed in symmetrical configuration of either two or four piping loops, constituting steam lines linear radially shortest routing configurations to either two or four turbine-generators, in symmetrical configuration of either two or four turbine buildings that flank the containment building; the expansion contraction devices continual configuring of composite construction exigent radial displacements assists entire plant configuration of the electromagnetic fluid devices to absorb most displacements and cyclical loads, and elastomeric bearings to absorb most of foundation displacements in tectonic movements forcing; the devices and bearings affect said construction least energy of distortion, maximally sustainable structural integrity and seal of plant boundaries that include subgrade bentonite slurry walls, for structures unbounded longevity and entirely safe operations, which minimally dissipate energy in maximal transfer of light fluids thermal energy into bulk electrical energy and yield thermal and mechanical highest efficiencies; thermodynamics hydrokinetics highest energy conserving, in seismically benign locality, orients condenser-units in elevation and thus the devices layout concentric with reactor vessel, including electromagnetic coils with concentric gap dispositions around the expansion contraction devices; the devices embody means for sustaining the plant locked in highest performance configurations that generating electrical power yield optimally friendly and beneficial operation in environment; in electrical power loss events, backstops granted minor overall movements and electromagnetic fluid confinement residual viscosity, assure the piping loops safe shutdown unimpaired integrity.

4. A PMIISP, comprising reactor vessel, high energy piping and turbine generator upright plane of symmetry affects thermal, static and dynamic loads and displacements symmetry in symmetry plane; confining structures electromagnetic fluid electromagnetic devices affect displacements in that plane and/or movements comprising vectorial sum in that plane with only infinitesimal other movements; axial displacements governing expansion and contraction electromagnetic device, in such plane, spawns high energy piping composite construction only preferred stressing, which by dissipating yields the PMIISP mechanical and thermal optimal efficiencies operational longevity; structures of the devices and confined fluid stiffness—elastic, shear, and bulk moduli spawned by power input into electromagnets—preclude other displacements; number of the planes is elective; and high energy piping optimally horizontal routings and condenser units cooling water optimum conservation orient the planes of symmetry and cooling water gravity flow means for flooding of annex and containment building portions up to the reactor vessel head set the PMIISP elevations.

5. The nuclear super plant of claim 3, wherein FIG. 2 described wall penetration device precision fabrications of complete compliments of surfaces, lubricating turbine paste-fluid surfaces in-wall axial prestress and thermal and negative tolerances prestress mechanical assemblies with thermal expansion innate biaxial compression comprise means for sealing containment wall penetrations.

6. The Advanced Processor of claim 1, wherein transportation vehicles over large water entities comprising superstructure shells embedded, enclosed, and optimally protected photoelectric cells comprise means for radiation energy conversion into electrical power; en masse retail utilizations of that radiation energy conversion, by such transportation devices, effectuates reduction in water evaporations and implements the PMII with FEIIPMII coordinated technologies energy transfers, engendering energy circulations in environment, which oppose EESD effects and assist effects of presently competent technology—powerful devices spawning capable means for opposing EESD.

7. The nuclear super plant of claim 3, wherein FIG. 2 described wall penetration device precision fabrications of complete compliments of surfaces, lubricating turbine paste-fluid surfaces in-wall axial prestress and thermal and negative tolerances prestress mechanical assemblies with thermal comprise means for sealing containment wall penetrations; wherein FIG. 3 integrated mechanical and electromagnetic assemblies constitute in-wall device electrical power means for magnetizing the assemblies and modulating electromagnetic fluid bulk modulus moduli as means for allowing the fluid three directional displacements that grant high energy piping means for three directional vectorial movement into least stressed disposition thru the wall penetration—attaining the piping means for highly flexible to high rigidity support stiffness; device modulating electrical power to electromagnets, in response to piping stresses extensometer readings, affects the support stiffness granting piping innate movements to low stress dispositions and the penetration seal redundancy; structures of the devices and confined fluid stiffness—elastic, shear, and bulk moduli spawned by power input into electromagnets preclude well within elastic strain range spurious displacements; each device functions in high energy equipment slow creep in the plane of symmetry effectuates electromagnetic means for locking piping system into maximal thermal, mechanical efficiencies.

8. The nuclear super plant of claim 3, wherein FIG. 4 described electromagnetic and mechanical assemblies embody complete complements high energy piping configuration and equipment base plates symmetrical about reactor vessel and turbine-generator upright plane of symmetry; in such configuration, displacements and loadings as affected force are transmitted, in symmetry plane of said configuration, and lateral loadings balanced and bounded within piping walls and equipment casings and upright loads balanced by piping and equipment weight and loads transmitted to base plates; the base plates in-situ elevations are set for high energy piping horizontally optimal routes affected said plane of symmetry; electrical power input to electromagnetic assemblies effectuates means for modulating the electromagnetic fluid stiffness moduli and bulk modulus that comprise means for dissipating large portions of thermal, static, and atoned static portion of dynamic loads by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming atones the dynamic loads oscillating amplitude short duration peaks portion, by dissipation of the peaks, in dynamic loads damping dissipated peaks as such fluid affects its return to elastic range; wherein, electromagnetic fluid creep affects and attunes the base plates granted major axis creep; the fluid brief excursion into inelastic range is artificial; it is controlled by extensometers, which monitor displacements with power supply sustained means for raising the fluid elastic range with means for raising fluid stiffness; displacements of base plates in the plane of symmetry effectuate movements in that plane of symmetry only granted transverse lateral infinitesimal displacements; structures of the devices and confined fluid stiffness—elastic, shear, and bulk moduli spawned by power input into electromagnets preclude well within elastic strain range spurious displacements; each device functions in high energy equipment slow creep in the plane of symmetry effectuates electromagnetic means for locking piping system into maximal thermal, mechanical efficiencies.

9. The nuclear super plant of claim 3 wherein FIG. 4A described electromagnetic and mechanical complete complements assemblies of bracing devices embody high energy piping displacements; said assemblies, in-situ configurations, are set for high energy piping horizontally optimal routes affected in planes of symmetry; electrical power input to electromagnetic assemblies effectuates means for modulating electromagnetic fluid stiffness, moduli and bulk modulus, which comprise means for dissipating large portions of thermal, static and atoned static portion of dynamic loads, by the assemblies granted movements; remainder small portions of the loads, except for the fluid further atoned dynamic loads portion, within magnetized elasticity range of said fluid, are passed to structures, comprising means for preferred stressing of structures; the fluid inelastic deforming attunes the dynamic loads oscillating amplitude short duration peaks portion by dissipation of the peaks, in dynamic loads damping dissipated peaks as such fluid affects its return to elastic range; wherein, electromagnetic fluid creep affects and attunes the braced member granted radial creep; the fluid brief excursion into inelastic range is artificial; it is controlled by extensometers, which monitor displacements with power supply sustained means for raising the fluid elastic range with means for increasing fluid stiffness; aforesaid spacers symmetry in the plane of symmetry affects movements in that plane of symmetry only granted transverse lateral infinitesimal displacements; structures of the devices and confined fluid stiffness—elastic, shear, and bulk moduli spawned by power input into electromagnets preclude well within elastic strain range spurious displacements; each device functions in high energy equipment slow creep in the plane of symmetry effectuates electromagnetic means for locking piping system into maximal thermal, mechanical efficiencies.

10. The nuclear super plant of claim 3, wherein FIG. 5 illustrated and described expansions and contractions device engendering electrical power input to electromagnetic assemblies effectuates means for modulating the electromagnetic fluid stiffness moduli and bulk modulus that comprise means for dissipating large portions of axial thermal, static and atoned static portions of dynamic loading in horizontal plane, by said assemblies permitted slow creep movements in reactor vessel and turbine upright plane of symmetry; remainder small portions of the loads, except for the fluid further attuning of dynamic loads portion within magnetized elastic range of the fluid, are passed to structures, comprising means for preferred stressing of structures; the fluid inelastic deforming attunes the dynamic loads oscillating amplitude short duration peaks portion by dissipation of the peaks, in dynamic loads damping dissipated peaks as such fluid affects its return to elastic range; wherein, electromagnetic fluid creep affects and attunes granted slow elastic creep in the device; the devices, piping configurations displacements optimally slow creep in the plane of symmetry yield electromagnetic means for locking piping system optimal thermal, mechanical efficiencies; the fluid brief excursion into inelastic range is artificial. It is controlled by extensometers which monitor displacements with power supply sustained means for raising the fluid elastic range with means for increasing fluid stiffness; aforesaid coaxial symmetry in the plane of symmetry affects movements in that plane of symmetry only granted transverse lateral infinitesimal displacements; thermal, static and dynamic loads granted optimally slow creep, in said plane of symmetry, from the reactor vessel to the turbine is coordinated thru extensometer readings for optimally preferred stressing of high energy piping loops, base plates and bracings effectuated by said displacements; structures of the devices and confined fluid stiffness—elastic, shear, and bulk moduli spawned by power input into electromagnets preclude well within elastic strain range spurious displacements; Each device functions in high energy equipment slow creep in the plane of symmetry effectuates electromagnetic means for locking piping system into maximal thermal, mechanical efficiencies.

11. The PMIISP according to claim 4, comprising symmetrical and/or in plane of symmetry displacements, with optimally horizontal routing of high energy piping, effectuated by electromagnetic devices and unique principles, methodologies, innovations, inventions (PMII) grant unique systematic principal strain theory of failure in systematized design and construction.

12. The super plant of claim 3, preferably comprising a shallow, at grade water retention dish, a stainless steel plate shell structure below grade, embodies water capacity requirements, embodies structural integrity which includes stainless steel ribs, grade beams, diaphragms and construction of heavy traffic roadway structural subgrade, to withstand seismic events; the beams, diaphragms and ribs comprise cutouts which facilitate required laminar flow rates, in unusual events, verified in hydraulics laboratory; wire reinforced concrete liner covering field spliced sheets of fiberglass comprises a protective liner for said shell; gravity flow from closest aqueduct keeps the dish full with piping means, including shutoff valves at each piping end, for inflowing and outgoing water circulation in or out of annex building compartments, and in a rare event gravity flow flooding of the primary containment; nuclear plant ancillary construction and berm shield of piping close to grade are known in the art; the structural integrity, the subgrade effectuates means for supporting mechanical cooling towers means for effecting the compartments essential cooling in rare events.

13. The nuclear super plant according to claim 3 comprises dome floor slab equipment access hermetical steel hatches—one above each SG; constructions of said hermetical hatches are known in the art; unbounded longevity of said super plant and the hatches effectuate primary containment polar crane access to annex building compartments and means for replacing or refurbishing SG through the annex building hermetical sliding doors and/or removable panels; the hatches comprise access means for robotically removing reactor vessel parts with equipment main hatch as access for reactor vessel replacement, planning for unbound longevity of the plant.

14. The PMIISP according to claim 4, comprising optional means for cooling either by cooling towers and atmosphere or underground aqueducts and epigene transferring of fluids mass and energy, wherein buried high density concrete aqueducts on structural subgrade with stainless steel lined inner surface supply cooling water by optimal flowing means for maximal heat energy and occasional irrigation fluids mass transfers and epigene optimal circulation opposed to EESD, and the PMIISP unprecedented thermal and mechanical efficiencies; exchanges in epigene fluids occurs when fluid temperature in aqueducts is less than environment surficial fluid temperatures.

15. The Advanced Processor according to claim 1, wherein the PMIISP underground aqueducts effectuate fluids energy highest conservation, by First Fluid Element sui-generis boundaries and in environment third circulating loop thermal exchange with epigene mass optimal heat sink, comprising fluids minimal energy losses optimal thermal energy transfers—highest mechanical and thermal efficiencies. Fluid Elements technology engendering longevities with the circulating loops heat energy optimal transfers avoid causal effects of fluids' evaporations, vapor emissions, and decoupling processes; all that diminishes amplitude of energy shortages, water scarcity, energy shortage innate and anthropogenic global warming (AGW) and abates suctions that effectuate the magnetic field lines periodic disconnects at shoulders of cusps.
